(19) United States
(12) Patent Application Publication
(10) Pub. No.: US 2018/0099220 A1
(43) Pub. Date: Apr. 12, 2018

(54) INPUT DEVICE AND GAME MACHINE USING SAME

(71) Applicant: KONAMI DIGITAL ENTERTAINMENT CO., LTD., Tokyo (JP)

(72) Inventors: Hiroshi HAYASAKA, Minato-ku (JP); Taiji YAMANAKA, Minato-ku (JP)

(21) Appl. No.: 15/837,218

(22) Filed: Dec. 11, 2017

Related U.S. Application Data
(63) Continuation of application No. PCT/JP2016/066892, filed on Jun. 7, 2016.

(30) Foreign Application Priority Data
Jun. 12, 2015 (JP) 2015-119035

(51) Int. Cl. A63F 13/24; A63F 13/814

(52) U.S. Cl. CPC A63F 13/24; A63F 13/814

(57) ABSTRACT

An input device is provided with: an operation member having an operation part, the intended operations thereof being pressing and rotation, and a shaft part that extends from the operation part in the direction of the pressing operation; a support structure having a bearing part that is attached in such a manner as to allow the shaft part to move back and forth along the axis thereof as well as to rotate about said axis; a spring member that provides the operation member with a restoring force against pressing operations; a pressing operation detecting switch that outputs a signal corresponding to the displacement of the operation member that occurs due to a pressing operation; and a rotation operation detecting mechanism that outputs a signal corresponding to the displacement of the operation member that occurs due to a rotation operation.

### CROSS-REFERENCE TO RELATED APPLICATION

The present application is a continuation of PCT Patent Application No. PCT/JP2016/066892, filed Jun. 7, 2016, which claims priority to Japanese Patent Application No. 2015-119035, filed Jun. 12, 2015, the disclosures of which are hereby incorporated by reference in their entirety.

### TECHNICAL FIELD

The present invention relates to an input device which is applied to a game machine or the like.

### BACKGROUND ART

Various types of devices and equipments such as a game machine are provided with input devices for detecting an operation of a user. For example, as a game-machine, there is known an exemplar one provided with a push-button-like input device for accepting a pressing operation by a user and an input device having a disc-like operation member for accepting a rotation operation by the user (cf. patent literatures #1 and #2, for example). There is also known a game machine where an input device is provided in such a way that an operation member to which a pressing operation and a sliding operation with respect to an almost horizontal direction are allowed, and another operation member, to which a rotation operation is allowed, having a ring shape is arranged at the outer circumference of the operation member (cf. patent literature #3, for example).

### CITATION LIST

### Patent Literature

PTL #1: JP-A-2000-084251.

PTL #2: JP-A-2000-126468.

PTL #3: JP-A-2014-144087.

### SUMMARY OF INVENTION

### Technical Problem

An input device which is configured by a combination of a first operation member for a pressing operation and a second operation member for a rotation operation prepared independently of the first operation member has some problems to be solved. For example, a user is required to decide clearly which operation member to use between the pressing operation and the rotation operation. Thereby, there is a possibility that the user suffers inconvenience such that an erroneous operation member is operated mistakingly, or there is a possibility that the user is flustered due to the switching operation between the pressing operation and the rotation operation. Further, since two types of operation members are provided, the number of parts increases and its structure is made complicated. Also, this could bring disadvantage for downsizing the device.

In view of the foregoing status of the art, it is an object of the present invention to provide an input device having a comparatively simple structure appropriate for the pressing operation and rotation operation.

### Solution to Problem

One aspect of the present invention provides an input device comprising: an operation member having an operation part which is an object to be operated for a pressing operation and a rotation operation and a shaft part which extends from the operation part in a direction of the pressing operation; a support structure having a bearing part to which the shaft part is placed so as to be allowed to reciprocate along an axial direction of the shaft part as well as rotate about an axis of the shaft part; a restoring force providing device which provides the operation member with a restoring force against the pressing operation; a pressing operation detecting device which outputs a signal corresponding to displacement of the operation member, the displacement occurring due to the pressing operation; and a rotation operation detecting device which outputs a signal corresponding to displacement of the operation member, the displacement occurring due to the rotation operation.

### BRIEF DESCRIPTION OF DRAWINGS

FIG. 1 is a perspective view of a game machine where an input device according to one embodiment of the present invention is applied;

FIG. 2 is a diagram showing one example of a game image executed on the game machine;

FIG. 3 is a perspective view of the input device according to the first embodiment;

FIG. 4 is a plan view of the input device according to the first embodiment;

FIG. 5 is a cross-section view taken along the line V-V in FIG. 4;

FIG. 6 is a cross-section view taken along the line VI-VI in FIG. 4;

FIG. 7 is a perspective view of the input device according to the second embodiment;

FIG. 8 is a perspective view of a rear-surface side of the input device according to the second embodiment;

FIG. 9 is a cross-section view taken along the same direction line as the line of FIG. 5 with respect to the input device according to the second embodiment; and

FIG. 10 is a cross-section view taken along the same direction line as the line of FIG. 6 with respect to the input device according to the second embodiment.

### DESCRIPTION OF EMBODIMENTS

### First Embodiment

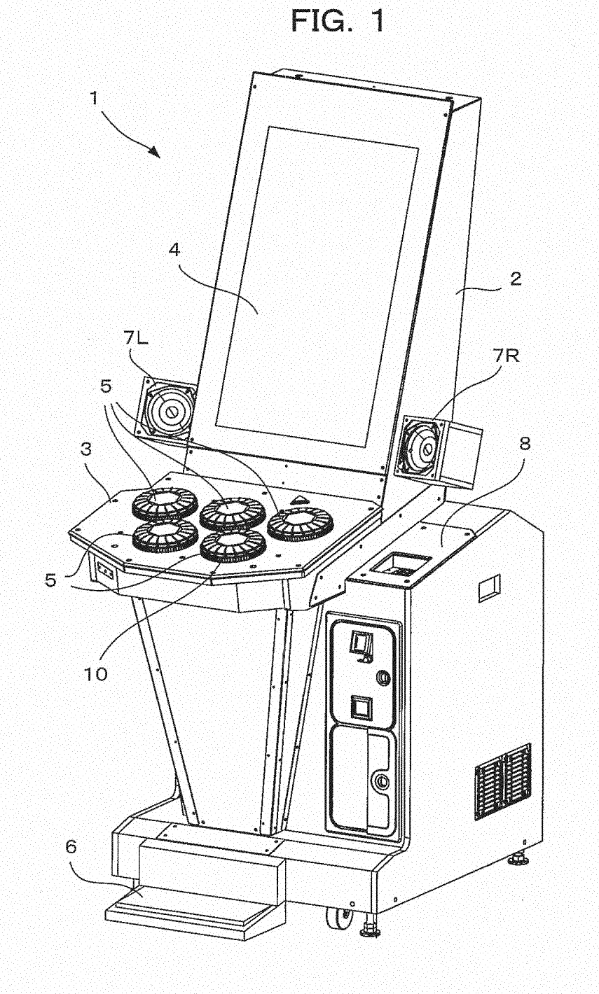

FIG. 1 shows one example of a game machine where an input device according to one embodiment of the present invention is applied. The game machine 1 has a chassis 2. The chassis 2 is constructed as an upright chassis where a user plays a game in a standing position. A central front portion of the chassis 2 is provided with a control panel 3. Above the control panel 3, a display device 4, which is vertically long, is provided. The control panel 3 is provided with a plurality of input devices 5 (five pieces of input devices are illustrated.). Each of the plurality of input devices 5 has a disc-like operation member 10, and outputs signals in response to a pressing operation and a rotation operation to the operation member 10 respectively. The input devices 5 are mounted to the chassis 2 so that the operation members 10 are arranged in near side and far side lines viewed from a user facing the display device 4 of the chassis 2. Two of the input devices 5 are arranged on the near side line, three of the input devices 5 are arranged on the far side line, and the operation members 10 of the input devices 5 are arranged in a zigzag manner. Further, at the front of the bottom portion of the chassis 2, a foot switch 6 is provided as another input device. The foot switch 6 outputs a signal in response to a stepping operation by a user. The game machine 1 is provided with, in addition to the above equipments, various kinds of equipments such as a speaker unit having a pair of right-left speakers 7L and 7R for reproducing music and a console unit 8 for dealing with payment of game-play charge, user verification, and the like.

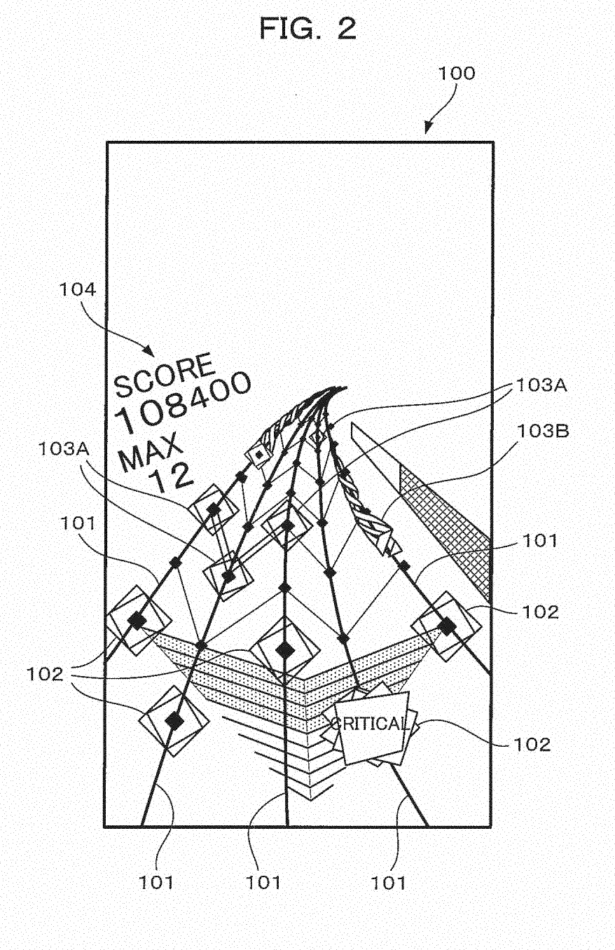

The game machine 1 has a computer therein, and is constructed so as to make a user play a game as appropriate, referring to the signal output from the input device 5. Hereinafter, one example of a game to be played at the game machine 1 will be described based on FIG. 2. It should be understood that the game which is played at the game machine 1 is not limited to the following example. As long as some control is executed in reference to signals output from the input device 5 in response to the pressing operation and rotation operation, the game which is played at the game machine 1 may be changed as appropriate.

A game image 100 shown in FIG. 2 is one example of a game image which is displayed in a music game where a user is required to perform the input devices 5 to music. The game image 100 is displayed on the display device 4 for the purpose of instructing the user on operations. In the game image 100, displayed are lanes 101 (five lanes are illustrated), the number of which is equal to the number of input devices 5. Each of the lanes 100 is represented in such a way as to extend from the backward side to the forward side in the game image. The five lanes 101 have a vertically structured relationship therebetween. In the example shown in FIG. 2, three of the lanes 101 are arranged on an upper side, and two of the lanes 101 are arranged on a lower side so that each of the two is located at each space between the three of the lanes 101 located on the upper side. The arrangement of the lanes 101 corresponds to the arrangement of the operation members 10 of the input devices 5 on the control panel 3. That is, the three lanes 101 located on the upper side correspond to the three operation members 10 arranged on the far side viewed from the user respectively, and the two lanes 101 located on the lower side correspond to the two operation members 10 arranged on the near side viewed from the user respectively. However, the arrangement of the lanes 101 may be changed as appropriate for a purpose such as increase of game enjoyability. Further, the direction where the lanes 101 extend may be changed as appropriate.

A reference mark 102 is displayed on the near side of each lane 101. The reference mark 102 corresponds to current time in the game. The arrangement of the reference marks 102 are correlated to the arrangement of the operation members 10 in a similar way to the lanes 101. Further, on the lane 101, timing marks 103A and 103B are displayed as appropriate. The timing mark 103A is displayed for instructing the user to operate the pressing operation to the operation member 10, and the timing mark 103B is displayed for instructing the user to operate the rotation operation to the operation member 10. The timing mark 103A is represented as a thin object with respect to a depth direction of the lane 101. On the other hand, the timing mark 103B is represented as an object having an appropriate length with respect to the depth direction of the lane 101. Further, in order to make the user recognize that the rotation operation is indicated, the timing mark 103B is represented in a spirally twisted shape.

Each of the timing marks 103A and 103B appears on the far side of the corresponding lane 101 at appropriate timing set in the music being reproduced in the game, and moves to the near side on the lane 101 at a speed synchronized with the music being reproduced. In conformity to the timing that the timing mark 103A reaches the reference mark 102, the user is required to perform the pressing operation to the operation member 10 corresponding to the reference mark 102. Further, when the timing mark 103B is moving to the reference mark 102, the user is required to perform the rotation operation to the operation member 10 corresponding to the reference mark 102. When in the game and to which operation member 10 the user should perform the pressing operation or the rotation operation are determined depending on the music to be reproduced in the game, a difficulty degree of the music, and the like. In a storage medium which is built in the game machine 1, data specifying the operation timing and the operation member 10 to be operated is recorded in advance. Based on the data, the appearing timing, the moving speed, and the like of each timing mark 103A, 103B are controlled by the computer of the game machine 1. During the game ongoing, it is determined based on comparison between the output signal of the input device 5 and the data whether the user has accurately performed the pressing operation or rotation operation instructed through the game image 100. In accordance with the determination result, a score of the user is calculated and displayed on a score display portion 104. As a degree of coincidence between the operation instructed on the game image 100 and the operation actually performed by the user increases, the score of the user becomes higher. Based on the score obtained by the user, the game result, for example, whether or not the music has been cleared, is determined.

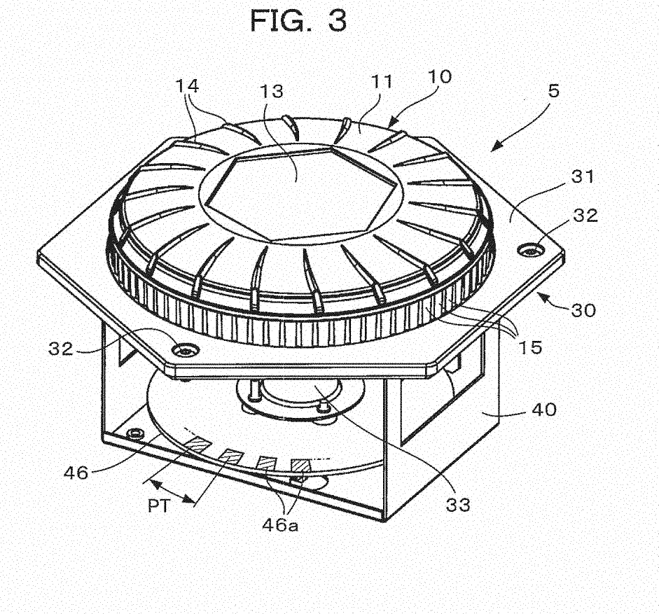

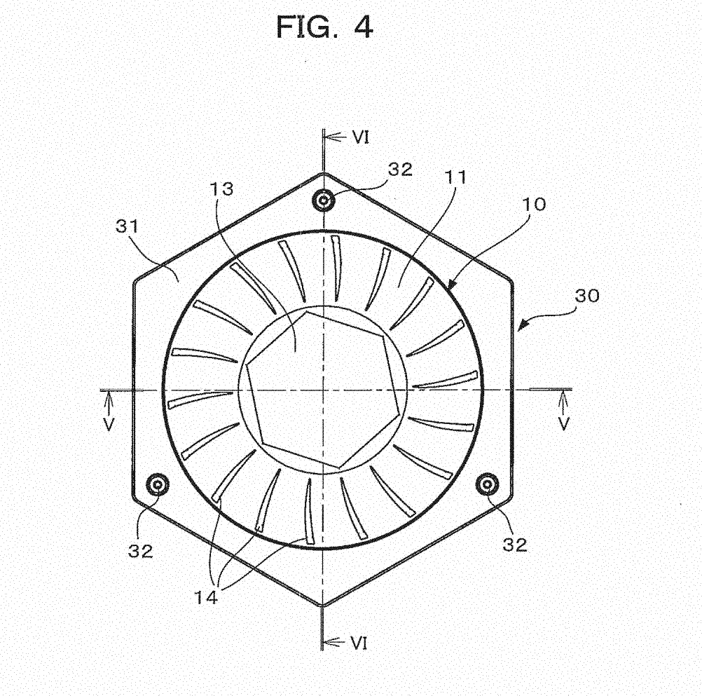

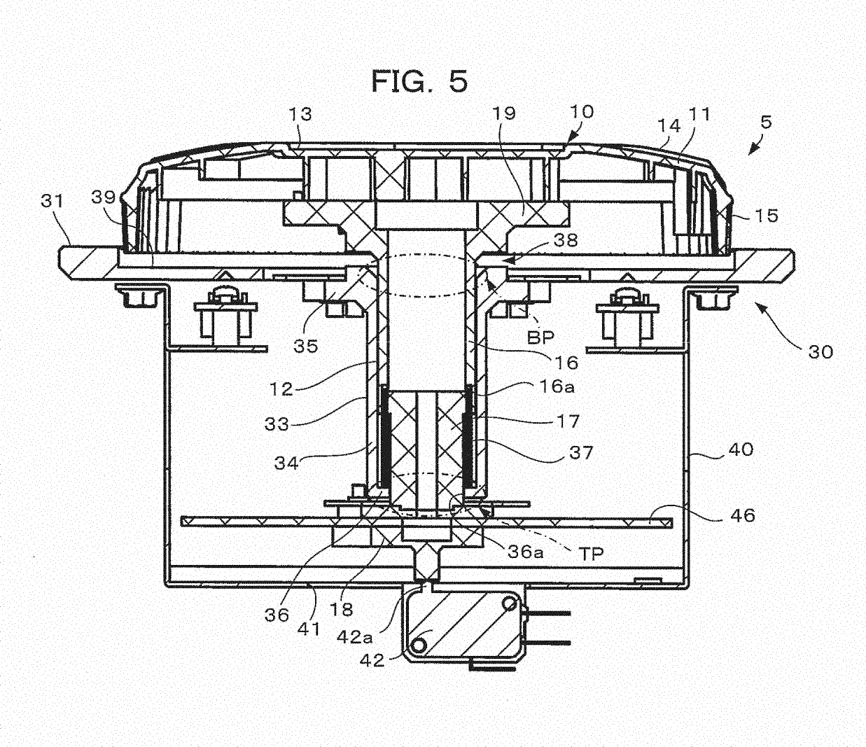

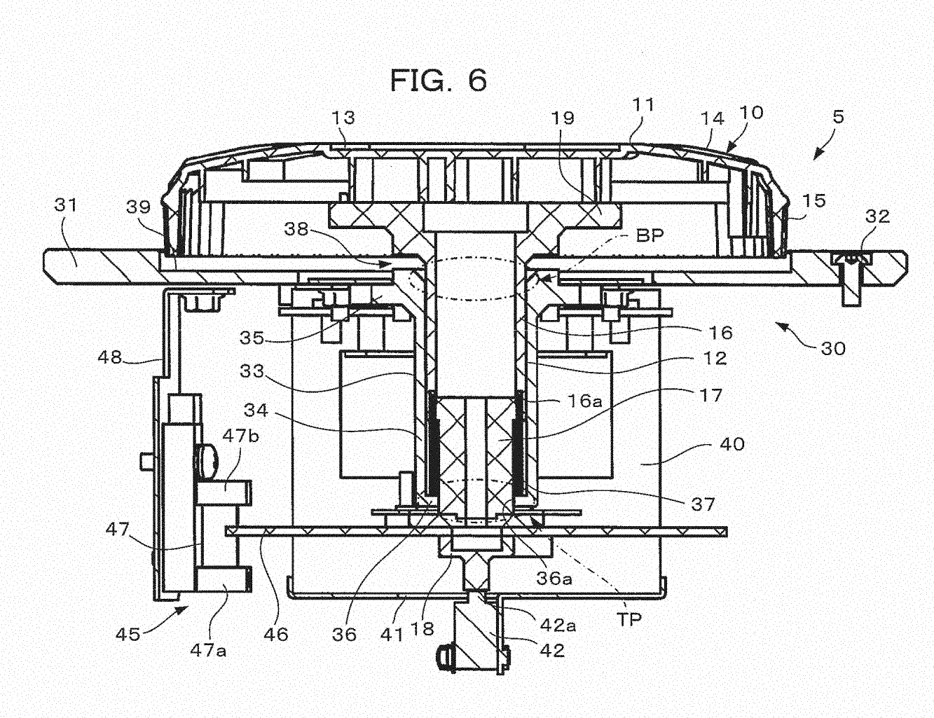

Next, in reference to FIGS. 3 to 6, the input device 5 will be described in detail. Each of the five input devices 5 provided to the game machine 1 has the same structure as each other. Due to this, the following describes about a single input device 5. The input device 5 has a support base 30 for supporting the operation member 10, as well as the operation member 10 mentioned above. As apparently shown in FIGS. 4 to 10, the operation member 10 has: an operation part 11 which is an operation object of the pressing operation and rotation operation; and a shaft part 12 extending in a direction of the pressing operation from the central portion of the rear-surface side (the lower surface side in FIGS. 5 and 6) of the operation part 11. As shown in FIGS. 3 and 4, the operation part 11 is formed in a shape having an almost disc-shaped appearance. A hollow portion 13 is provided to the central portion of the front-surface side of the operation part 11, the hollow portion 13 being shallow and hexagonally shaped. The hollow portion 13 functions as a symbol makes the user recognize the central portion of the operation part 11 where the pressing operation should be performed. Around the hollow portion 13, a plurality of prominent portions 14 are arranged in the circumferential direction at constant intervals. Each of the plurality of prominent portions 14 is formed in such a way as to be bent somewhat with respect to a radial direction of the operation part 11. Further, at the outer circumference of the operation part 11, a plurality of convex portions 15 are arranged in the circumferential direction. The prominent portions 14 and the convex portions 15 are provided for the user to hitch easily his/her fingers or hand to the operation part 11, thereby perform an effect of suppression of slipping which occurs at the moment of the rotation operation. The hollow portion 13, the prominent portions 14, and the convex portions 15 are not necessary elements to the operation member 10, and may be omitted as appropriate.

As shown in FIGS. 5 and 6, the shaft part 12 has a first engaging shaft part 16, a second engaging shaft part 17, a cap part 18, and a flange part 19. The second engaging shaft part 17 is coaxially provided at a tip side of the first engaging shaft part 16, and has a diameter somewhat smaller than the first engaging shaft part 16 has. The cap part 18 is coaxially connected to a tip side of the second engaging shaft part 17. The flange part 19 is provided to a back-end side of the second engaging shaft part 17. The flange part 19 is integrally connected to the central portion of the operation part 11. Thereby, the operation part 11 and the shaft part 12 are coaxially fixed to each other, and are allowed to integrally move along the axial direction and in the circumferential direction with respect to the shaft part 12.

As shown in FIGS. 3 to 6, the support base 30 has a basal plate 31. The basal plate 31 is formed in an almost hexagonal shape, and near the vertexes thereof, a plurality of bolt holes 32 (three bolt holes 32 are illustrated) are provided (see FIGS. 3 and 6) for fitting the input device 5 to the control panel 3 of the game machine 1. As shown in FIGS. 5 and 6, a shaft holder 33 is placed as a bearing part at the central portion of the rear-surface side of the basal plate 31. The shaft holder 33 has a cylindrical portion 34 and a flange portion 35 which is provided in such a way as to expand outward from the upper end of the cylindrical portion 34. The cylindrical portion 34 is formed in an almost cylindrical shape. The flange portion 35 is fixed to the central portion of the rear-surface side of the basal plate 31. Accordingly, the shaft holder 33 composes one part of the support base 30 together with the basal plate 31.

At the lower end of the cylindrical portion 34, a spring receiver 36 is formed in such a way as to project somewhat toward the center of the cylindrical portion 34. At the center of the spring receiver 36, a penetrating hole 36a is formed coaxially with the cylindrical portion 34. With respect to a portion except the spring receiver 36, the inner diameter of the cylindrical portion 34 is constant. The inner diameter of the cylindrical portion 34 is set to a size that the cylindrical portion 34 is allowed to engage with the first engaging shaft part 16 of the shaft part 12 with an appropriate backlash which allows the first engaging shaft part 16 to slide on the inner surface of the cylindrical portion 34 in the axial direction and circumferential direction. The inner diameter of the penetrating hole 36a is set to a size that the penetrating hole 36a is allowed to engage with the second engaging shaft part 17 with an appropriate backlash which allows the second engaging shaft part 17 to slide on the inner surface of the penetrating hole 36a in the axial direction and circumferential direction.

When the shaft part 12 is inserted into the cylindrical portion 34 in a state that the shaft holder 33 is fixed to the basal plate 31, the first engaging shaft part 16 is engaged with the cylindrical portion 34 and the second engaging shaft part 17 is engaged with the penetrating hole 36a of the spring receiver 36. Thereby, the shaft part 12 is placed to the shaft holder 33 in such a way as to be allowed to reciprocate along the axial direction and rotate around the axis with respect to the shaft holder 33. When the shaft part 12 is mounted to the shaft holder 33, a spring member 37 as one example of a restoring force providing device is mounted on the outer circumference of the second engaging shaft part 17. The spring member 37 is a coil spring as one example, and is coaxial with the second engaging shaft part 17. By the insertion of the shaft part 12 to the cylindrical part 34, the spring member 37 is butted against the spring receiver 36 and is sandwiched between the spring receiver 36 and a groove-like spring receiver 16a provided to an end of the second-engaging-shaft-part-17 side of the first engaging shaft part 16.

After the second engaging shaft part 17 is inserted into the penetrating hole 36a, the cap part 18 of the shaft part 12 is connected with the second engaging shaft part 17 from the outside (the lower side) of the spring receiver 36. By the connection with the cap part 18, the spring member 37 is somewhat compressed. Due to the compression of the spring member 37, an upward restoring force (a repelling force) acts on the operation member 10. The restoring force acts on the spring receiver 36 and the first engaging shaft part 16, and thereby each of the spring receiver 36 and first engaging shaft part 16 functions as an action portion of the restoring force. Since the operation member 10 is pushed upward by the restoring force of the spring member 37, the cap part 18 is pressed on the lower end of the spring receiver 36. Thereby, the position of the operation member 10 for a state that no pressing operation is performed to the operation member 10 is determined with respect to a vertical direction, and the operation member 10 is prevented from penetrating upwardly. That is, the cap part 18 functions as a device which determines the position of the operation member 10 with respect to the vertical direction for a state that no pressing operation is performed, and also stops the operation member 10 to penetrate. Hereinafter, the position of the operation member 10 corresponding to a state that no pressing operation is performed and the cap part 18 is contacting with the spring receiver 36, is called a steady-stable position.

When the operation member 10 is located at the steady-stable position, a clearance 38 for allowing the pressing operation to the operation part 11 occurs between the flange part 19 of the shaft part 12 and the upper end of the shaft holder 33. Accordingly, the pressing operation to the operation part 11 is enabled until the flange part 19 is butted against the upper end of the shaft holder 33. The front surface side of the basal plate 31 is provided with a concave portion 39. When the operation member 10 is located at the steady-stable position, the outer circumference of the operation part 11 comes into the concave portion 39 somewhat.

A bracket 40 is placed on the rear-surface side of the basal plate 31. The bracket 40 is a sheetmetal part which has been bent in a tub shape. At the bottom of the bracket 40, a penetrating window 41 is formed. When the operation member 10 is located at the steady-stable position, a tip of the shaft part 12, that is, a tip of the cap part 18 is located slightly higher than the penetrating window 41. A micro switch 42 is fitted to the bracket 40. The micro switch 42 has a press-button type plunger 42a which contacts with the tip of the cap part 18. When the operation member 10 is displaced downward by the pressing operation, the plunger 42a is pushed into the micro switch 42, and then an inner contact point of the micro switch 42 is electrified. Thereby, a signal indicating detection of the pressing operation is outputted from the micro switch 42. Accordingly, the micro switch 42 functions as one example of a pressing operation detecting device which outputs a signal corresponding to displacement according to the pressing operation to the operation member 10.

As shown in FIG. 6, the input device 5 is also provided with a rotation operation detecting mechanism 45 as one example of a rotation operation detecting device which outputs a signal corresponding to displacement caused by the rotation operation to the operation member 10. The rotation operation detecting mechanism 45 comprises a rotary disk 46 and a pair of photo sensors 47. The rotary disk 46 is coaxially placed to the cap part 18 and rotates integrally with the shaft part 12 around the axis of the shaft part 12. Each of the pair photo sensors 47 outputs a signal corresponding to rotary displacement of the rotary disk 46. The rotary disk 46 is made from a material having permeability with respect to visible wavelengths. As apparently shown in FIG. 3, on the outer circumference of the rotary disk 46, light-shielding portions 46a are arranged in a circumferential direction at constant intervals. Only one part of the light-shielding portions 46a are illustrated in FIG. 3, and the light-shielding portions 46a are provided over the whole circumference of the rotary disk 46 at a constant angle pitch PT.

As shown in FIG. 6, the photo sensor 47 is fitted to the basal plate 31 via a sensor supporting plate 48. The photo sensor 47 is a so-called photo-interrupter type sensor, which emits detection light having visible wavelengths from a light emitting portion 47a to a light receiving portion 47b and outputs a signal corresponding to intensity of the detection light detected by the light receiving portion 47b. Each photo sensor 47 is placed to the basal plate 31 so that the outer circumferential portion of the rotary disk 46 is located between the light emitting portion 47a and the light receiving portion 47b. Accordingly, the signal outputted from the photo sensor 47 changes depending on whether or not the light-shielding portion 46a is passing between the light emitting portion 47a and the light receiving portion 47b. When the light-shielding portion 46a is taken as a detection portion, a signal outputted from the photo sensor 47 for the moment when the light-receiving portion 47b receives no detection light is taken as a signal corresponding to the detection of the detection portion. Alternatively, each interspace between the light-shielding portions 46a may be taken as the detection portion. In this case, a signal outputted from the photo sensor 47 for the moment when the light-receiving portion 47b is receiving the detection light is taken as a signal corresponding to the detection of the detection portion.

The distance between the light-emitting portion 47a and light-receiving portion 47b of the photo sensor 47 is set so that the light-emitting portion 47a and light-receiving portion 47b do not contact with the rotary disk 46 even when the rotary disk 46 is displaced with respect to the vertical direction due to vertical motion of the operation member 10. The pair of photo sensors 47 (only one of the photo sensors 47 is illustrated in FIG. 6) are appropriately spaced from each other with respect to the circumferential direction of the shaft part 12. The angle distance of the photo sensors 47 with respect to the circumferential direction is set, based on the angle pitch PT of the circumferential direction of the light-shielding portion 46a, to a value other than the integral multiple of PT/2. The reason is because the rotational direction of the rotary disk 46 is determined by using a phase difference of detection signals from the pair of the photo sensors 47.

According to the input device 5 constructed as mentioned above, when the user operates the operation part 11 to perform the pressing operation, a whole of the operation member 10 is displaced downward, and due to this displacement, the detection signal of the pressing operation is outputted from the micro switch 42. On the other hand, when the user operates the operation part 11 to perform the rotation operation, the detection signal of the light-shielding portion 46a is repeatedly outputted from the photo sensor 47 in accordance with the rotational amount and rotational speed, and, based on a sequence of the detection signals, it is possible to determine the rotational amount, rotational speed, and rotational direction of the operation part 11. That is, the rotational amount is possible to be determined based on the number of times that the light-shielding portion 46a has been detected, the rotational speed is possible to be determined based on the rotational amount and time, and the rotational direction is possible to be determined based on the phase difference between the detection signals of the photo sensors 47. In the game machine 1, it is determined based on the signal from the micro switch 42 whether the user has accurately performed the pressing operation instructed by the timing mark 103A, and also determined based on the signal from the photo sensor 47 whether the user has accurately performed the rotation operation instructed by the timing mark 103B. Based on the determination results, it is possible to execute various kinds of controls, such as calculation of user's score.

With respect to the input device 5 in the present embodiment, both of the pressing operation and the rotation operation are performed to the operation part 11 of the operation member 10 shared by the operations. Accordingly, it is not necessary for a user to decide clearly which operation member to use between the pressing operation and the rotation operation. Accordingly, a possibility that a user performs an erroneous operation is excluded, or a possibility that a user is flustered due to the switching between the pressing operation and the rotation operation is decreased. Further, it is not necessary to prepare operation members, different from each other, for the pressing operation and the rotation operation respectively. Accordingly, it is possible to decrease the number of parts, simplify the structure of the input device 5, and prompt to downsize the input device 5.

The first and second engaging shaft parts 16 and 17 are provided to the operation member 10, and the almost all length of the first engaging shaft part 16 and the tip portion of the second engaging shaft part 17 are engaged with the cylindrical portion 34. Thereby, it is possible to reliably support with respect to a radial direction by the shaft holder 33, a base portion BP lying on the operation part 11 side of the first engaging shaft part 16, that is, the end portion of the side connected with the flange 19, and a tip portion TP of the second engaging shaft part 17. Due to this, it is possible to suppress slippage of the shaft part 12 to the pressing operation, and it is possible to enhance stability of the reciprocating motion and rotational motion of the operation member 10. Further, since the spring member 37 for returning the operation member 10 to the steady-stable position is arranged coaxially with the first and second engaging parts 16 and 17, it is possible to make the restoring force of the spring member 37 work evenly along the axis of the shaft part 12. Therefore, it is possible to further reliably suppress the slippage of the shaft part 12 caused by unevenness of the restoring force. Since the tip portion TP of the engaging shaft part 17 is supported by the shaft holder 33, the motion of the tip side of the shaft part 12 is made stable. Accordingly, it is possible to reliably detect the pressing operation by using the micro switch 42.

### Second Embodiment

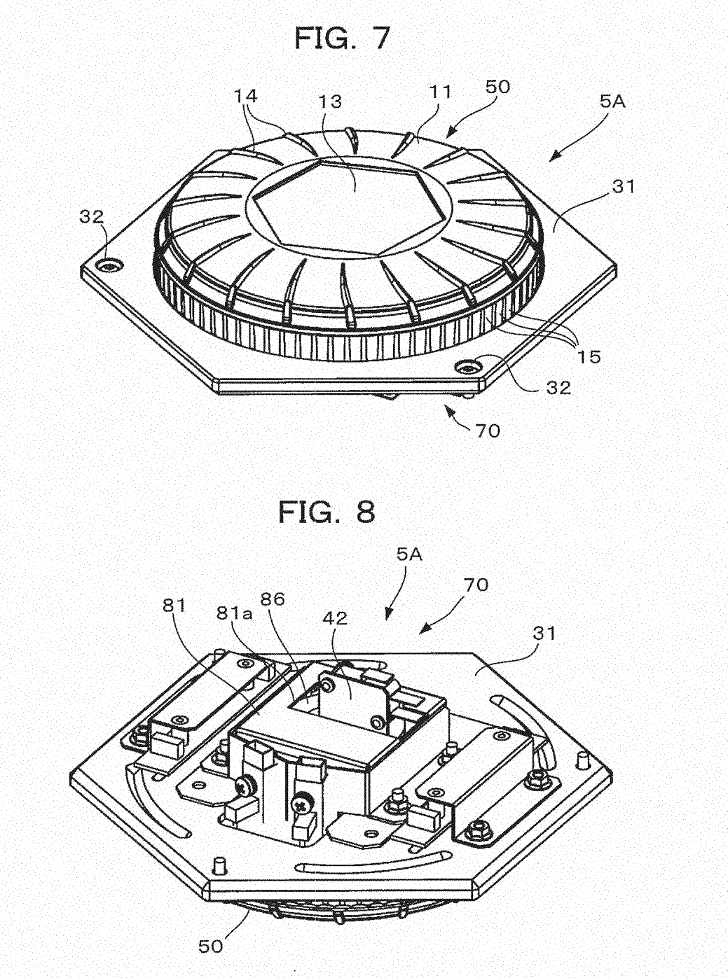

Next, in reference to FIGS. 7 to 10, an input device according to a second embodiment will be described. An identical reference symbol is given to each element shared with the first embodiment, and the following mainly describes different points between the first and second embodiments. Since an input device according to the present embodiment is applied to the game machine 1 shown in FIG. 1, with respect to the structure of the game machine 1 and the game which is played at the game machine 1, the explanations for FIGS. 1 and 2 are applied to the present embodiment as they are.

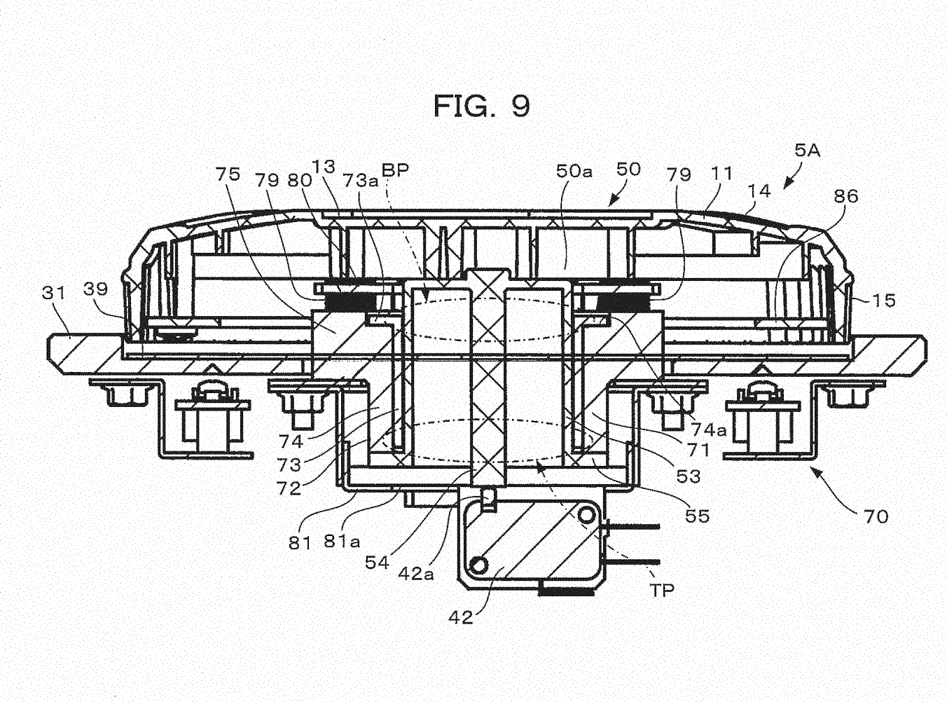

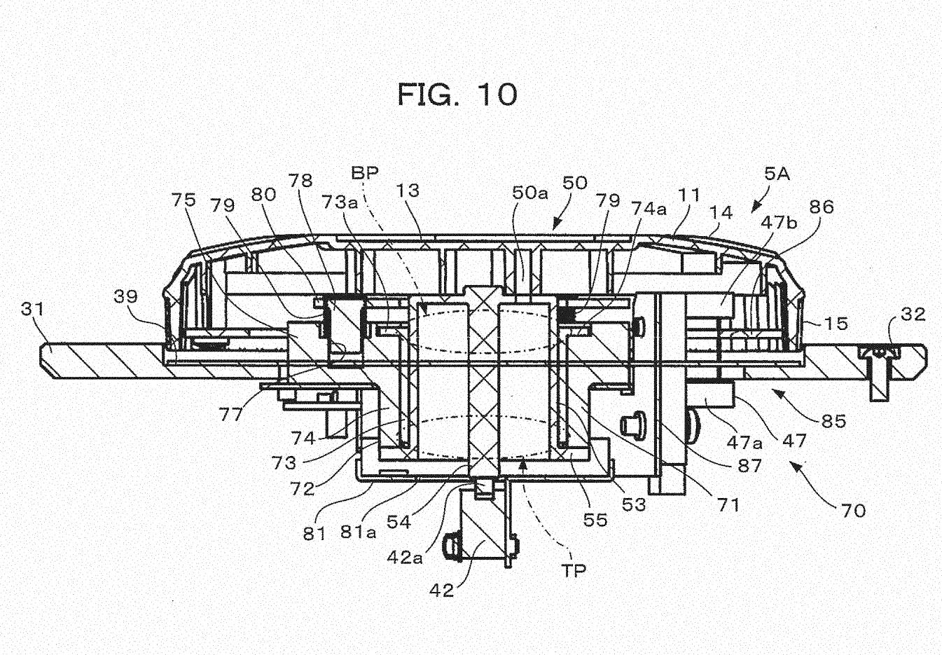

As shown in FIGS. 7 and 8, also in the present embodiment, an input device 5A has an operation member 50 and a support base 70. However, the support base 70 is constructed more thinly with respect to the vertical direction in comparison with the support base 30 of the first embodiment. As shown in FIGS. 9 and 10, the operation member 50 has the operation part 11 and a shaft part 52 extending in a direction of the pressing operation from the rear-surface side of the operation part 11. The operation part 11 is the same as the operation part 11 of the operation member 10 of the first embodiment. On the other hand, the shaft part 52 has an engaging shaft part 53 formed in a cylindrical shape and an operational shaft part 54 provided on the axis of the shaft part 52. The engaging shaft part 53 is coaxial with the operational shaft part 54. The upper end of the engaging shaft part 53 is connected with the central portion of the rear surface side of the operation part 11 so as to be coaxial with the operation part 11. The tip (the lower end) of the engaging shaft part 53 is provided with a flange portion 55 expanding outward.

On the other hand, the support base 70 is provided with the basal plate 31 and a shaft holder 71 fitted to the basal plate 31. The basal plate 31 is the same as the basal plate 31 of the input device 5 of the first embodiment, except for details such as positions of screw holes for fitting another member. The shaft holder 71 has a housing 72 and a sleeve 73 which is inserted to the inner circumference of the housing 72. The housing 72 has a cylindrical portion 74 which is formed in a cylindrical shape having a constant inner diameter and a flange portion 75 which is provided so as to expand outward from the upper end of the cylindrical portion 74. The flange portion 75 is fixed to the central portion of the rear-surface side of the basal plate 31, and thereby the shaft holder 71 composes one part of the support base 70 together with the basal plate 31.

At the upper end of the cylindrical portion 74, a concave portion 74a is formed. The sleeve 73 is integrally engaged with the inner circumference of the cylindrical portion 74, and a flange portion 73a, which is the upper end of the sleeve 73, is housed in the concave portion 74a, and butted against a bottom surface of the concave portion 74a with respect to the axial direction. The housing 72 and the sleeve 73 are not allowed to displace relatively to each other. Accordingly, the shaft holder 71 (the assembled structure of the housing 72 and sleeve 73) functions as a bearing part. The engaging shaft part 53 is inserted to the inner circumference of the sleeve 73 from the lower side of the sleeve 73, and connected in such a way as to be coaxial with the operation part 11, with a boss 50a located at the center of the rear surface of the operation part 11. The inner diameter of the sleeve 73 is set to a size that the sleeve 73 is allowed to engage with the engaging shaft part 53 with an appropriate backlash which allows the engaging shaft part 53 to slide on the inner surface of the sleeve 73 in the axial direction and circumferential direction. The engaging shaft part 53 is engaged with the inner circumference of the sleeve 73, and thereby the shaft part 52 is fitted to the shaft holder 71 in such a way as to be allowed to reciprocate along the axial direction and rotate around the axis with respect to the shaft holder 71. The flange portion 55 of the engaging shaft part 53 is butted against the lower end of the housing 72. Thereby, the operation member 50 is prevented from penetrating upwardly. In the present embodiment, the position of the operation member 50 corresponding to a state the flange portion 55 is contacting with the lower end of the housing 72, is called a steady-stable position of the operation member 50.

As shown in FIG. 10, the flange portion 75 of the shaft holder 71 is provided with a plurality of pin holes 77 (three pin holes as one example). The pin holes 77 are located so as to surround the shaft part 52 and arranged in the circumferential direction of the shaft part 52 at constant intervals. Pins 78 are engaged with the pin holes 77 respectively so as to be allowed to move in the axial direction (the vertical direction). To the outer circumference of each of the pins 78, a spring member 79, which is one example of a restoring force providing device, is attached. The upper end of the pin 78 is connected with a friction plate 80 which is one example of a friction member. The friction plate 80 has a ring shape as one example. The friction plate 80 is joined with the pins 78 in a state that the friction plate 80 are placed coaxially with the shaft part 52. The pin 78 and friction plate 80 are able to integrally move in the axial direction. The spring member 79 is a coil spring as one example. The spring member 79 is provided so as to be sandwiched between the flange portion 75 and the friction plate 80.

When the operation member 50 is located at the steady-stable position, the spring member 79 is somewhat compressed. Due to the compression of the spring member 79, the friction plate 80 is pressed to the operation part 11 of the operation member 50. Thereby, an upward restoring force (a repelling force) acts on the operation member 50. Between the shaft holder 71 and the operation member 50, the restoring force of the spring member 79 acts on the flange portion 75 of the shaft holder 71 and the boss 50a provided at the center of the operation part 11 of the operation member 50. Thereby, each portion 75, 50a functions an action portion of the restoring force. Since the operation member 50 is pushed upward by the restoring force of the spring member 79, the flange portion 55 is pressed to the lower end of the housing 72, and thereby the position of the operation member 50 is determined as the steady-stable position. That is, the flange portion 55 functions as a device which determines the position of the operation member 50 with respect to the vertical direction and also stops the operation member 50 to penetrate. Further, the friction plate 80 is pressed to the rear-surface side of the operation part 11, and thereby frictional resistance is generated between the operation member 50 and the friction plate 80 according to a spring load of the spring member 79 and a frictional coefficient of the surface of the friction plate 80. Accordingly, when the operation member 50 is operated for the rotation operation, an appropriate frictional force acts against the rotational motion of the operation member 50. Accordingly, by adjusting appropriately the spring constant and deflected amount of the spring member 79 and the frictional coefficient of the friction plate 80, it is possible to restrict appropriately free rotation of the operation member 50 by its inertia. Alternatively, it is possible to provide an appropriate sense of resistance against the rotation operation to the operation member 50. When the operation member 50 is located at the steady-stable position, the lower end of the pin 78 is located above the bottom of the pin hole 77. Accordingly, for the pressing operation, the operation member 50 is allowed to operate until the pin 78 contacts with the bottom of the pin hole 77.

A bracket 81 (see FIG. 8) is placed on the rear-surface side of the basal plate 31. The bracket 81 is provided with the micro switch 42 as with the first embodiment. A penetrating window 81a is formed in the bracket 81. The plunger 42a of the micro switch 42 and the tip of the operational shaft part 54 contacts with each other through the penetrating window 81a. Accordingly, when the operation member 50 is operated for the pressing operation, the plunger 42a is pressed into the micro switch 42 and thereby the detection signal of the pressing operation is outputted from the micro switch 42.

As apparently shown in FIGS. 9 and 10, a rotation operation detecting mechanism 85, one example of a rotation operation detecting device, is provided between the rear-surface side of the operation part 11 and the front-surface side of the basal plate 31. The rotation operation detecting mechanism 85 comprises a rotary disk 86 and the pair of photo sensors 47 (in FIG. 10 only one of the photo sensors is shown.). The rotary disk 86 is fixed to the rear-surface side of the operation part 11 so as to rotate integrally with the operation member 50. The rotary disk 86 is made from a material having permeability with respect to visible wavelengths, as with the rotary disk 46 of the first embodiment. However, the rotary disk 86 has a ring shape. On the inner circumferential portion of such a rotary disk 86, light-shielding portions 46a similar to the light-shielding portions 46a of the first embodiment are provided in the circumferential direction at constant intervals.

As shown in FIG. 10, the photo sensor 47 is fitted to the basal plate 31 via a sensor supporting plate 87. As with the photo sensor of the first embodiment, the photo sensor 47 is a so-called photo-interrupter type sensor. Each photo sensor 47 is placed to the basal plate 31 so that the inner circumferential portion of the rotary disk 86 is located between a light emitting portion 47a and a light receiving portion 47b. Accordingly, the signal outputted from the photo sensor 47 changes depending on whether or not the light-shielding portion 46a is passing between the light emitting portion 47a and the light receiving portion 47b. The distance between the pair of photo sensors 47 with respect to the circumferential direction of the shaft part 52 is similar to the distance in the first embodiment.

According to the input device 5A mentioned above, the pressing operation performed by the user to the operation part of the operation member 50 is detected with the micro switch 42, while the rotation operation performed by the user to the operation part of the operation member 50 is detected with the photo sensors 47, and the detection signal is provided to the computer of the game machine 1. Thereby, it is possible to control the game in a similar way to the first embodiment. Further, since both of the pressing operation and the rotation operation are performed to the operation part 11 of the operation member 50 shared by the operations, a possibility that a user performs an erroneous operation is excluded, and also a possibility that a user is flustered due to the switching between the pressing operation and the rotation operation is decreased. Further, since the number of parts is decreased, it is possible to simplify the structure of the input device 5A and prompt to downsize the input device 5A.

Since the operation member 50 is provided with the engaging shaft part 53 and almost all length of the engaging shaft part 53 is engaged with the sleeve 73, it is possible to make the shaft holder 71 as a bearing part support with respect to the radial direction a base portion BP lying on the operation part 11 side of the engaging shaft part 53 and a tip portion TP of the engaging shaft part 53. Due to this, it is possible to suppress slippage of the shaft part 52 to the pressing operation, and it is possible to enhance stability of the reciprocating motion and rotational motion of the operation member 50. Since the tip portion TP of the engaging shaft part 53 is supported by the shaft holder 71, it is possible to make the motion of the tip side of the shaft part 52 stable, and reliably detect the pressing operation by using the micro switch 42. Further, since the plurality of spring members 79 are arranged so as to surround the shaft part 52, it is unnecessary to provide on the engaging shaft part 53, an engagement portion where the spring member is engaged. Due to this, the engaging shaft part 53 can be shorten with respect to the axial direction, and thereby it is possible to prompt to downsize the input device 5A, especially make the shaft part 52 thinner with respect to the axial direction.

The present invention is not limited to the above embodiments, and various changes and variations can be applied. For example, the arrangement of spring member as the restoring force providing device is not limited to such an example that a spring member is arranged on outer circumference of the engaging shaft part or arranged around the engaging shaft part, the spring member may be arranged on the inner circumferential side of the shaft part. The engaging shaft part of the shaft part may be formed in a hollow-cylindrical shape, and the inner circumference thereof may be supported by the bearing part. The restoring force providing device is not limited to a coil spring, and various kinds of spring members such as a torsion spring or a flat spring may be employed. The restoring force is not limited to the one using a repelling force against compression, and may be generated by using a repelling force against a pulling force. The restoring force providing device is not limited to a spring member, and an elastic member such as gum or urethane may be employed as appropriate as long as the restoring force is generated against the pressing operation. In the above embodiments, not only the tip portion TP and base portion BP of the engaging shaft part, but also the middle portion between the portions TP and BP is supported by the baring part. However, in light of suppression of the slippage of the shaft part, it is sufficient that at least the tip portion TP and base portion BP are supported by the bearing part.

In the first embodiment, the spring member 37 is fitted to the spring receiver 36, which is the action portion on the support base 30 side, so as not to rotate relatively to the spring receiver 36, and is fitted to the spring receiver 16a of the first engaging shaft part 16, which is the action portion on the operation member 10 side, so as to rotate relatively to the spring receiver 16a. In the second embodiment, the spring member 79 is fitted to the flange portion 75, which is the action portion on the support base 30 side, so as not to rotate relatively to the flange portion 75, and is fitted to the boss 50a of the operation member 50, which is the action portion on the operation member 50 side, so as to rotate relatively to the boss 50a. However, the spring member 37, 79 may be fitted to the action portion on the operation member 10, 50 side so as to rotate integrally with the operation member 10, 50. In this case, the spring member 37, 79 becomes possible to rotate relatively to the action portion on the support base 30, 70 side. The friction plate 80 is provided only to the input device 5A of the second embodiment. However, also in the first embodiment, a friction plate may be provided so as to intervene between the spring receiver 16a of the first engaging shaft part 16 and the spring member 37. In a case that the spring member 37, 79 is fitted to the operation member 10, 50 side, the friction plate 80 may be fitted to the operation member 10, 50 so as not to rotate relatively to the action portion on the operation member 10, 50 side, in a similar way to the spring member 37, 79. For example, in the second embodiment, possible is the following variation: the spring member 79 is fitted to the operation member 50 side; and the friction plate 80 is arranged between the spring member 79 and the flange portion 75. The friction member is not limited to a member having a plate-like shape, and various shapes such as pad-like or block-like may be applied to the friction member.

The pressing operation detecting device is not limited to an example that a micro switch is employed, and an appropriate detecting device such as a proximity switch or a photo sensor may be employed as long as the detecting device can output a signal corresponding to displacement caused by the pressing operation to the operation member. Not only the detecting device which switches a signal depending on whether or not the operation member has been pressed, but also a detecting device which changes the intensity of signal according to the operation amount of the pressing operation may be employed as the pressing operation detecting device. Also, the rotation operation detecting device is not limited to the illustrated example. An appropriate detecting device may be employed as long as the detecting device can output a signal corresponding to displacement caused by the rotation operation to the operation member. In the illustrated example, the rotation operation detecting device is constructed so as to determine the rotational speed and rotational direction. However, only some of the items may be set as the object(s) to be detected.

In the above each embodiment, the example that the input device is applied to the game machine was described. However, an object where the input device should be applied is not only a game machine. Various kinds of devices and equipments may be employed as the object. In the above each embodiment, the input device is constructed so that the operation member is allowed to freely rotate around the axis of the shaft part. However, the rotational angle of the operation member may be limited to a predetermined range. The following embodiment may be also applied to an embodiment of the present invention: a device (for example, a torsion spring) which provides the operation member with restoring torque against the rotation operation is further added; and when a user leaves his/her hand from the operation part, the operation member may rotate so as to return to its original position.

The following describes about various aspects of the present invention, which can be derived from the above mentioned embodiments and variations.

One aspect of the present invention provides an input device comprising: an operation member having an operation part which is an object to be operated for a pressing operation and a rotation operation and a shaft part which extends from the operation part in a direction of the pressing operation; a support structure having a bearing part to which the shaft part is placed so as to be allowed to reciprocate along an axial direction of the shaft part as well as rotate about an axis of the shaft part; a restoring force providing device which provides the operation member with a restoring force against the pressing operation; a pressing operation detecting device which outputs a signal corresponding to displacement of the operation member, the displacement occurring due to the pressing operation; and a rotation operation detecting device which outputs a signal corresponding to displacement of the operation member, the displacement occurring due to the rotation operation.

According to the input device of the above embodiment, the shaft part extending in the direction of the pressing operation from the operation part of the operation member is reciprocably and rotatably fitted to the bearing part of the support structure, and the operation member is provided with the restoring force against the pressing operation by the restoring force providing device. Thereby, it is possible to make the operation part operate for both of the pressing operation and the rotation operation.

In the above embodiment, the shaft part may be provided with an engaging shaft part which is engaged with the bearing part reciprocably and rotatably, and the bearing part may be provided so as to be engaged reciprocably and rotatably with at least a tip portion and base portion on the operation part side of the engaging shaft part. According to this embodiment, at least the tip and base portions of the engaging shaft part are supported by the bearing part.

Further, the pressing operation detecting device may be provided so as to detect displacement of the tip portion of the shaft part, the displacement occurring due to the pressing operation. In a case that the tip portion of the engaging shaft part is supported by the bearing part, the motion of the tip side of the shaft part is stable.

In the above embodiment, the rotation operation detecting device may comprise: a rotary plate which is placed to the operation member in an integrally rotatable matter, and has a plurality of detection portions arranged at intervals in a circumferential direction; and a sensor which is placed to the support structure so as to detect pass of each of the plurality of detection portions, the pass occurring due to the rotation operation to the operation member, and outputs a signal corresponding to detection of each of the detection portions. According to this embodiment, when the operation member and the rotary disk rotates integrally with each other, the plurality of detection portions sequentially passes the detection range of the sensor, and each time passing the detection range, the detection signal is outputted from the sensor.

Between the support structure and the operation member, a spring member as the restoring force providing device may be provided coaxially with the shaft part. According to this embodiment, the restoring force of the spring member can be made to evenly work along the axis of the shaft part.

Alternatively, between the support structure and the operation member, a plurality of spring members may be provided, each being as the restoring force providing device, and the spring members are arranged in a circumferential direction of the shaft part around the shaft part at intervals.

In the above embodiment, the spring member may be provided so as not to rotate in a direction of the rotation operation relatively to a first action portion within action portions of the restoring force, the action portions lying in the operation member and the support structure respectively, and between the spring member and a second action portion within the action portions, a friction member may be provided so as not to rotate in a direction of the rotation operation relatively to the first action portion, the friction member being pressed to the second action portion by the restoring force of the spring member. In this case, when the operation member is rotating, the frictional force works between the friction member and the second action portion.

A further aspect of the present invention provides a game machine comprising the input device according to any one of the above embodiments, wherein the game machine is configured so as to control a game in reference to signals outputted from the pressing operation detecting device and the rotation operation detecting device of the input device respectively.

What is claimed is:

1. An input device comprising:
an operation member having an operation part which is an object to be operated for a pressing operation and a rotation operation and a shaft part which extends from the operation part in a direction of the pressing operation;
a support structure having a bearing part to which the shaft part is placed so as to be allowed to reciprocate along an axial direction of the shaft part as well as rotate about an axis of the shaft part;
a restoring force providing device which provides the operation member with a restoring force against the pressing operation;
a pressing operation detecting device which outputs a signal corresponding to displacement of the operation member, the displacement occurring due to the pressing operation; and
a rotation operation detecting device which outputs a signal corresponding to displacement of the operation member, the displacement occurring due to the rotation operation.

2. The input device according to claim 1, wherein
the shaft part is provided with an engaging shaft part which is engaged with the bearing part reciprocably and rotatably, and the bearing part is provided so as to be engaged reciprocably and rotatably with at least a tip portion and base portion on the operation part side of the engaging shaft part.

3. The input device according to claim 2, wherein the pressing operation detecting device is provided so as to detect displacement of the tip portion of the shaft part, the displacement occurring due to the pressing operation.

4. The input device according to claim 1, wherein
the rotation operation detecting device comprises: a rotary plate which is placed to the operation member in an integrally rotatable matter, and has a plurality of detection portions arranged at intervals in a circumferential direction; and a sensor which is placed to the support structure so as to detect pass of each of the plurality of detection portions, the pass occurring due to the rotation operation to the operation member, and outputs a signal corresponding to detection of each of the detection portions.

5. The input device according to claim 1, wherein
between the support structure and the operation member, a spring member as the restoring force providing device is provided coaxially with the shaft part.

6. The input device according to claim 1, wherein
between the support structure and the operation member, a plurality of spring members are provided, each being as the restoring force providing device, and the spring members are arranged in a circumferential direction of the shaft part around the shaft part at intervals.

7. The input device according to claim 5, wherein
the spring member is provided so as not to rotate in a direction of the rotation operation relatively to a first action portion within action portions of the restoring force, the action portions lying in the operation member and the support structure respectively, and
between the spring member and a second action portion within the action portions, a friction member is provided so as not to rotate in a direction of the rotation operation relatively to the first action portion, the friction member being pressed to the second action portion by the restoring force of the spring member.

8. A game machine comprising the input device according to claim 1, wherein the game machine is configured so as to control a game in reference to signals outputted from the pressing operation detecting device and the rotation operation detecting device of the input device respectively.
